(19) United States
(12) Patent Application Publication
(10) Pub. No.: US 2026/0343697 A1
(43) Pub. Date: Oct. 29, 2026

(54) A CONTROL CIRCUIT FOR DETECTING AN INTERRUPTION OF THE INPUT POWER

(71) Applicant: SIGNIFY HOLDING B.V., EINDHOVEN (NL)

(72) Inventors: CHENG YU, SHANGHAI (CN); XIANGDONG ZHANG, SHANGHAI (CN)

(21) Appl. No.: 19/103,622

(22) PCT Filed: Aug. 7, 2023
(86) PCT No.: PCT/EP2023/071770

§ 371 Date: Feb. 13, 2025

(30) Foreign Application Priority Data
Aug. 15, 2022 (WO) PCT/CN2022/112458
Sep. 26, 2022 (EP) 22197615.2

(51) Int. Cl. H05B 45/14

(52) U.S. Cl. CPC H05B 45/14

(57) ABSTRACT

It is provided a control circuit used with an appliance (40) with a power supply unit (PSU) that receives an input power (AC) and provides an output voltage (VBUS) to a variable load (LED), comprises a detection circuit adapted to detect a drop in the output voltage (VBUS) and determine an interruption of the input power (AC) accordingly, and a configuring circuit adapted to configure the appliance according to the determined interruption of the input power (AC), characterized in that said detection circuit is adapted to detecting a power level of the load (LED); and determine the interruption of the input power if the output voltage (VBUS) drops below a first threshold (Vth1) in case that the power level of the load is at a first level (25%); determine the interruption of the input power if the output voltage (VBUS) drops below a second threshold (Vth2) in case that the power level of the load is at a second level (50%); wherein the first level (25%) and the second level (50%) are different, and the first threshold (Vth1) and the second threshold (Vth2) are different.

### FIELD OF THE INVENTION

The present invention relates to the field of power electronics.

### BACKGROUND OF THE INVENTION

Many lighting appliances do not have any mechanical control parts to configure them. They may have a wireless control interface wherein the user can configure it via a wireless terminal such as a smart phone. But configuring it via the smart phone is often a little inconvenient. Therefore many lighting appliances, with the wireless control interface or without, has an additional capability of detecting the interruption of input power, and configure the lighting appliance via how many the interruption of the input power is. This interruption (and restoration) of input power called as toggle. Users can toggle the input power by turn off and on the switch connected with the lighting appliance, and the lighting appliance receives such power toggle. Nowadays it already becomes an important approach to configure the appliance's state, like set the lighting appliances to swap its light state such as brightness, color temperature among a plurality of available states, etc., or even reset the lighting appliance to factory default, etc.

FIG. 1 shows a typical architecture of an LED lighting appliance that is capable of controlling the brightness of the LED based on the power toggle. AC is the AC mains input power. A switch 12, such as a wall switch, is connected between the AC mains input power and the LED lighting appliance 10. The LED lighting appliance 10 has a power supply unit PSU to receive the AC mains input power, and convert the AC mains input power into an output voltage VBUS over a bus. Usually, the PSU has a large output capacitor C at its output to the bus so as to smooth the output voltage. The LED lighting arrangement LED is connected on the bus and powered by the output voltage, optionally via a unshown current regulator since LED is preferred to be current-driven. A controller shown as MCU generates a pulse width modulation PWM signal to control how often the LED is powered by the output voltage thus adjusts the brightness of the LED. At last, a control circuit shown as an op-amp compares the output voltage VBUS on the bus with a certain threshold Vth. As shown, the output voltage VBUS is at the non-inverting input of the op-amp and the certain threshold Vth is at the inverting input of the op-amp, such that when the output voltage VBUS is lower than the certain threshold Vth, the op-amp will output a high signal and the appliance determines that the input power has been interrupted and will inform the controller. The user toggles the switch off, and keep it off to allow the output voltage VBUS drops below the threshold and the interruption can be detected, then the user may toggle the switch on. Optionally the op-amp can also detect when the output voltage VBUS restores. And this interruption and restoration constitute a complete turn off and on, power toggle. So the controller would adjust its PWM signal from a previous state to a next state. For example, before the toggle, the PWM's duty cycle is 50% so as to set the lighting appliance at a medium brightness level. After the toggle, the MCU sets the PWM's duty cycle to 25% so as to set the lighting appliance at a low brightness level. And next time the toggle is detected, the MCU sets the PWM's duty cycle to 0% so as to set the lighting appliance at standby. The reason that the output voltage VBUS is used for determining the interruption of the input power, instead of the AC input of the PSU, is that it is difficult to detect and process the AC side signal by the controller etc. at the DC side, but detecting and processing the DC side signal VBUS is easy since the controller is at the same side/ground with respect to the DC side signal VBUS.

The inventors find that, with different load power level of the LED lighting arrangements, the time for the output voltage VBUS to reach such threshold varies a lot, and it is difficult to achieve a consistent user behavior for different load power level.

The reason is that, with the output capacitor C, the load consumes the energy in the output capacitor C at different rate if the load power level is different. A LED lighting arrangement set at 25% duty cycle consumes power at a rate around half of that LED lighting arrangement set at 50% duty cycle. Thus for the output voltage VBUS to reach the threshold Vth, the 25% duty cycle case takes twice the time of that for the 50% duty cycle case. As shown in FIG. 2, when at zero time the toggle switch 12 is open with the original operation of heavy load, 50% duty cycle, e.g., the LED lighting arrangement working in heavy load draws power from the output capacitor C quickly and the output voltage VBUS is relative fast to reach the threshold Vth at time T. When at zero time the toggle switch is open with small load, e.g., at 25% duty cycle, or even at standby state wherein the LED lighting arrangement does not emit light, the output capacitor C is slowly discharged by the small load and the output voltage VBUS might take much longer to reach the threshold, at T′.

In implementation, if the threshold is set low, it is OK for determining the interruption in the heavy load case; but when the system works in small load, the user needs to toggle the switch off for a very long time to allow the output voltage to drop below this threshold. Firstly, such long time may intolerable; second, the user's interaction with the switch is different in heavy load and small load and this is especially unfriendly. If threshold is set high, the fluctuation of the output voltage in heavy load case is often large and may drop below threshold high threshold even when the input power is not interrupted and mis-trigger the threshold. It is difficult to find a proper threshold.

EP3125650A1 discloses a solution to detect excess output based on a voltage drop at the output, and the degree of voltage drop can be determined by capacitance in the device.

### SUMMARY OF THE INVENTION

The invention is defined by the claims.

A basic idea of the invention is providing an adjustability for the threshold that determines the interruption of the input power, according to the real load power level. If the load is a heavy load, when the input power is lost/toggled off, the output voltage drops more, and a lower threshold is configured; and if the load is small load, when the input power is interrupted/toggled off, the output voltage drops less, and a high threshold is configured. In this way, the user can keep the switch off for a same time duration to allow the output voltage to drop below the threshold and trigger the successful determination of the interruption, no matter what level the load is. The voltage would drop below a respective threshold with more confidence and the toggle can be accurately determined.

In a first aspect of the invention, it is provided a control circuit for use with an appliance with a power supply unit that is adapted to be connected to and receive an input power and adapted to provide an output voltage to a power-variable load, said control circuit comprises a detection circuit adapted to detect a drop in the output voltage and determine an interruption of the input power accordingly, and a configuring circuit adapted to configure the appliance according to the determined interruption of the input power, characterized in that said detection circuit is adapted to detecting a power level of the load, determine the interruption of the input power if the output voltage drops below a first threshold in case that the detected power level of the load is at a first level, and determine the interruption of the input power if the output voltage drops below a second threshold in case that the detected power level of the load is at a second level; wherein the first level and the second level are different, and the first threshold and the second threshold are different.

The first aspect uses different threshold for the output voltage in different load power levels. Thus the decreasing speed of the output voltage in different load power levels is considered and an interruption of the input power can be accurately detected, regardless of the power level of the loads. Therefore the present application can support a wide operation range of the load.

In a further embodiment, the first level is smaller than the second level, and the first threshold is higher than the second threshold. For a small load case, the threshold is set higher; for a heavy load case, the threshold is set lower. It takes similar time for the output voltage to drop below respective threshold, thus the user just needs to toggle the switch off for a similar time, regardless of what the load power level is. This provides acceptable and consistent operation time for the user and is user-friendly.

In a further embodiment, the first and the second thresholds are sized such that when the input power is interrupted, the output voltage drops below said first threshold by a certain time duration when the load is at the first level, and the output voltage drops below said second threshold by the substantially same certain time duration when the load is at the second level.

In this embodiment, the time for the output voltage to drop below respective threshold is substantially same. This is consistent for the user and is user-friendly.

In a further embodiment, said detection circuit comprises a comparing circuit to compare the output voltage with a reference, a first circuit to detect the power level of the load, and a second circuit to set either the first threshold or the second threshold as the reference for the comparing circuit, according to the detected power level of the load.

This embodiment provides a detailed implementation for the detection circuit.

In a further embodiment, said first circuit comprises a current detector to detect a current from the power supply unit to the power-variable load, and a processing circuit to determine the power level of the load according to the detected current.

The current from the power supply is relevant with the load power level: when the load power level is heavy, the (average/mean) current is definitely large; and vice versa. Thus the current can indicate the load power level.

In alternative embodiment, the controller of the appliance already knows the present load power level and can inform the second circuit to set a corresponding threshold.

In a further embodiment, said configuring circuit is adapted to configure the appliance in an setting, among a plurality of settings, according to how many times the interruption of the input power is detected.

In this embodiment, the number of interruptions in a sequence of interruptions and back to normal state without interruption again, determines what is to configure. For example, a successive three toggles/interruptions and back to normal (no more interruptions) controls the appliance to change its load power level to medium; successive four toggles/interruptions and back to normal controls the appliance to small load power level; successive five toggles/interruptions and back to normal controls the appliance to standby load power level; and successive six toggles/interruptions and back to normal controls the appliance to factory default load power level.

In a more detailed embodiment, said configuring circuit is adapted to: start counting the interruption when the interruption is detected for a first time; time a period and count an interruption if the interruption occurs within the period, and repeat the timing and counting; stop counting if no interruption occurs within a last period; configure the appliance in one setting corresponding to counted times of the interruptions.

In this embodiment, a period can be timed by a timer to determine whether there is an incoming interruption, and the interruptions is counted and the period is reset to detect future interruptions. If no interruption within a last period, it is determined that this is the end of the interruptions and the appliance is configured according to how many interruptions are counted. The advantage of this embodiment is that the user can configure the appliance into a desired setting quickly by entering a corresponding sequence of interruptions.

In an alternative embodiment, the configuring circuit is adapted to configure the appliance to a next setting in a sequence of settings each time the interruption of the input power is detected.

This alternative embodiment controls the appliance to change its state each time one interruption is received. This is an alternative toggle control for the appliance. The advantage of this embodiment is that the user does not need to memorize a specific sequence of the power interruption corresponding to that desired setting, but the appliance would change to a next setting automatically and the user can stop once the appliance enters the desired setting.

In a second aspect of the present invention, it is provided a LED driving appliance comprising a power supply unit and a control circuit according to the previous aspect and embodiment.

In a third aspect of the present application, it is provided a LED lighting appliance comprising the LED driving appliance according to the second aspect and a LED lighting arrangement as the variable load.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows the general architecture of a LED lighting appliance and a toggle switch to configure the LED lighting appliance;

FIG. 2 shows the threshold in the prior art and the waveform of output voltages in heavy load case and small load case respectively;

FIG. 3 shows the general architecture of a LED lighting appliance according to an embodiment of the present application and a toggle switch to configure the LED lighting appliance; and

FIG. 4 shows the thresholds configured by an embodiment of the present invention and the waveform of output voltages in heavy load case and small load case respectively.

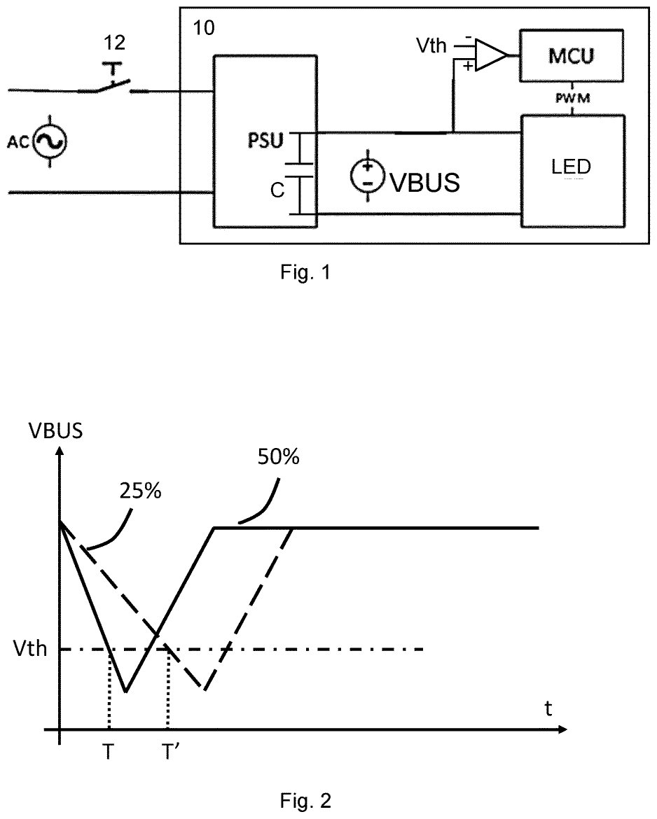

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

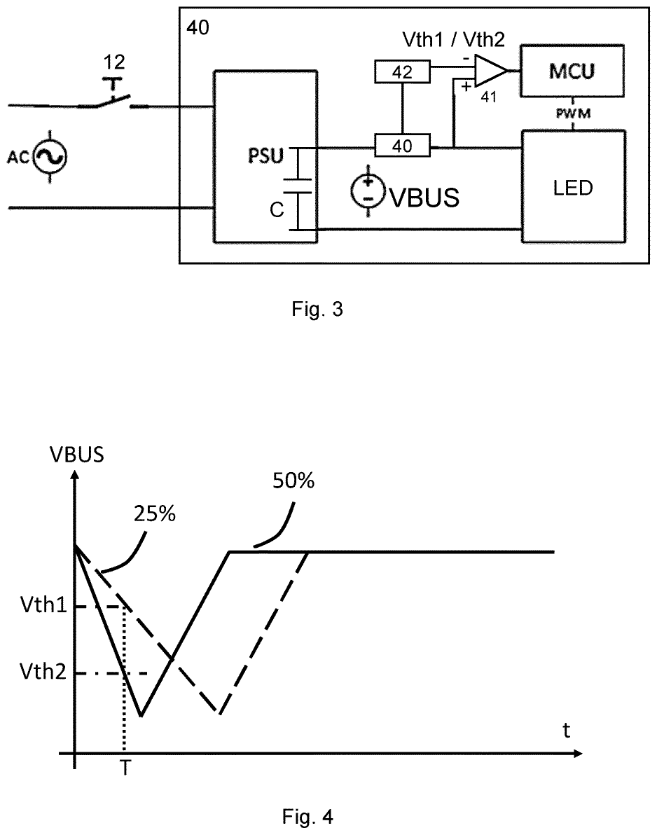

FIG. 3 shows an architecture of an LED lighting appliance 40 that is capable of controlling the brightness of the LED based on the power toggle according to an embodiment of the present application. AC is the AC mains input power. A switch 12, such as a wall switch, is connected between the AC mains input power and the LED lighting appliance 40. The LED lighting appliance 40 has a power supply unit PSU to receive the AC mains input power, and convert the AC mains input power into an output voltage VBUS over a bus. Usually, the PSU could be an AC-DC power supply (alternatively be DC-DC power supply if the input power is DC), and has a large output capacitor C at its output to the bus so as to smooth the output voltage. The LED lighting arrangement LED is connected on the bus and powered by the output voltage VBUS, optionally via a unshown current regulator since LED is preferred to be current-driven.

Most importantly, the appliance 40 comprises a control circuit to determine the interruption of the input power. The control circuit comprises
a detection circuit adapted to detect a drop in the output voltage VBUS and determine an interruption of the input power AC accordingly, and
a configuring circuit adapted to configure the appliance according to the determined interruption of the input power AC. It could be implemented by the controller shown as MCU generates a pulse width modulation PWM signal to control how often the LED is powered by the output voltage thus adjusts the brightness of the LED.

Wherein, said detection circuit is adapted to
determine the interruption of the input power if the output voltage VBUS drops below a first threshold Vth1 in case that the load is at a first level;
determine the interruption of the input power if the output voltage VBUS drops below a second threshold Vth2 in case that the load is at a second level;
wherein the first level and the second level are different, and the first threshold Vth1 and the second threshold Vth2 are different.

In the embodiment shown in FIG. 3, the detection circuit comprises
a comparing circuit 41 to compare the output voltage VBUS with a reference,
a first circuit 40 to detect a power level of the load, and
a second circuit 42 to set either the first threshold or the second threshold as the reference for the comparing circuit, according to the detected power level of the load.

More specifically, the comparing circuit 41 is for example an op-amp 41 compares the output voltage VBUS on the bus with a threshold dynamically set as Vth1 or Vth2. As shown, the output voltage VBUS is at the non-inverting input of the op-amp and the threshold Vth is at the inverting input of the op-amp, such that when the output voltage VBUS is lower than the threshold, the op-amp outputs a high signal and the appliance determines that the input power has been interrupted and will inform the configuring circuit/the controller MCU. Optionally the op-amp can also detect when the output voltage VBUS restores. And this interruption and restoration constitute a complete turn off and on, power toggle.

The configuring circuit/controller MCU would adjust its PWM signal from a previous state to a next state, for example, before the toggle, the PWM's duty cycle is 50% so as to set the lighting appliance at a medium brightness level. After the toggle, the MCU sets the PWM's duty cycle to 25% so as to set the lighting appliance at a small brightness level. And next time the toggle is detected, the MCU sets the PWM's duty cycle to 0% so as to set the lighting appliance at a standby mode.

More specifically, the first level is smaller than the second level, and the first threshold Vth1 is higher than the second threshold Vth2. More preferably, the thresholds are set such that the output voltage VBUS drops below said first threshold Vth1 by a certain time duration T when the load is at the first level, and the output voltage drops below said second threshold Vth2 by the substantially same certain time duration T when the load is at the second level.

FIG. 4 shows the thresholds configured by an embodiment of the present invention and the waveform of output voltages in heavy load case and small load case respectively. Taking a 25% brightness as the first load power level, when at zero time the toggle switch 12 is open with the original operation with this load power level, 25% duty cycle, e.g., the LED lighting arrangement draws power from the output capacitor C slowly and the output voltage VBUS reaches/drops below the a higher threshold Vth1 at time T. Taking a 50% brightness as the second load power level, when at zero time the toggle switch 12 is open with the original operation with this load power level, 50% duty cycle, e.g., the LED lighting arrangement draws power from the output capacitor C faster and the output voltage VBUS reaches/drops below the threshold Vth2 at same time T.

Therefore, regardless of the load power level, the user can toggle the switch off and keep it off for a same duration longer than T so as to make the output voltage drops below a respectively threshold, and toggle the switch on again. The comparing circuit would detect this drop below threshold and would inform the configuring circuit about this interruption of input power. Thus the user can control the appliance with a single and consistent off/on timing beat (or rhythm) of the toggling and the user's experience is friendly.

The below table 1 provides more examples of the thresholds correspond to different load power levels. Assume the VBUS is 16V at normal operation before the interruption.

TABLE 1

| Load | threshold (T = 3 seconds) |
|---|---|
| 20 W (full load) | 0.5 V |
| 5 W | 5 V |
| 2 W | 7 V |
| 1 W | 9 V |
| 0.5 W | 10 V |
| 0.2 W | 11 V |
| 0.1 W | 12 V |
| 0.05 W | 13 V |
| 0.02 W | 14 V |
| 0.01 W | 15 V |

For example, given the toggle off time is 3 second, the threshold is 0.5V for detecting the interruption at full load 20 W; and the threshold is 7V for detecting the interruption at a small load 2 W. The detection circuit may maintain/pre-store such a mapping table, and selecting a threshold corresponding to the load power level in real time. Even more, the detection circuit can interpolate a threshold for a load power level based on the available data in the table, when a load power level and a corresponding threshold is not explicitly written in the table.

Alternatively, a formula to calculate a threshold from a load power level can be stored in the detection circuit, and the detection circuit can use this formula to determine a threshold corresponding to a load power level.

The first circuit 40 has many implementations: it could be a current detector between the power supply unit PSU and the load LED, and to detect the average current provided to the load LED. A larger average current means a larger load power level; vice versa.

Alternatively, the first circuit 40 can access and analyze the PWM signal provided by the controller MCU to the load. The higher the duty cycle of the PWM signal, the larger the load power level; vice versa. Further alternatively, the controller MCU can directly inform the first circuit 40 which output power level the LED lighting appliance is.

The present invention can be used with different toggle configuration schemes, for example either the progressive toggling or sequence toggling.

The progressive toggling is that the configuring circuit progressively change to a next setting in a sequence of settings each time the interruption of the input power is detected. When the present setting is the last setting in the sequence, the configuring circuit return to the first setting of the sequence and start again. For example, in power up of the LED lighting appliance the output is configured as 100%; upon each interruption, the configuring circuit would decrease the output by 25%, namely sequentially 100%, 75%, 50%, 25%, 0% (standby). A next setting of 0% is 100% again, and repeat.

The sequence toggling is that the configuring circuit identifies a sequence of interruptions and configuring the LED lighting appliance in one setting, among a plurality of settings, corresponding to the sequence. For example, a sequence of only one interruption (meaning there is no interruption following a first interruption with a detected period long enough) may map to 100% output. A sequence of two successive interruptions (meaning there is a second interruption following a first interruption with a detected period starting from the first interruption with, and there is no interruption following the second interruption within a detected period starting from the second interruption) may map to 75% output. A sequence of three interruptions maps to 50%; four to 25%; five to 0% (standby). A sequence of six successive interruptions may map to reset the lighting appliance to factory default. In this case, assume the lighting appliance is in 50% output and the user want to quickly change it into 100% output, the user can just toggle the switch once to enter one interruption.

The control circuit can be completely implemented in the MCU running a firmware executing the above defined functions. Or, the control circuit can be fully or partly implemented by discrete circuits, while the remaining part, if any, is implemented by the MCU running a firmware executing the remaining functions. Those skilled in the art understand that there are many ways to implement the embodiments of the invention.

The above embodiment uses LED lighting appliance as an example. The present application is not limited in this application. As long as an appliance needs to determine an interruption of the input power, the present application can be used.

The input power is not limited as AC mains, but could also be an AC power from an inverter powered by a DC power source such as solar panel or battery, or be a DC power from a DC power supply powered by an AC power source or a DC power source. Said DC power supply powered by an AC power source could be like a low voltage 48V AC-DC power supply powered by an AC mains, such as used in a 48V track light system. Said DC power supply powered by a DC power source could be a DC-DC converter powered by a battery or solar panel. In all of these applications, the interruption of input power into the appliance can be used to command the appliance, and the present application can be used for determining this interruption.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A control circuit for use with an appliance with a power supply unit that is adapted to be connected to and receive an input power and to adapted to provide an output voltage to a power-variable load, said control circuit comprises:
a detection circuit adapted to detect a drop in the output voltage and determine an interruption of the input power accordingly, and
a configuring circuit adapted to configure the appliance according to the determined interruption of the input power,
wherein said detection circuit is adapted to:
detecting a power level of the load; and
determine the interruption of the input power if the output voltage drops below a first threshold in case that the detected power level of the load is at a first level, and determine the interruption of the input power if the output voltage drops below a second threshold in case that the detected power level of the load is at a second level;
wherein the first level and the second level are different, and the first threshold and the second threshold are different.

2. A control circuit according to claim 1, wherein the first level is smaller than the second level, and the first threshold is higher than the second threshold.

3. A control circuit according to claim 1- or 2, wherein said first threshold and said second threshold are determined such that when the input power is interrupted, the output voltage drops below said first threshold by a certain time duration when the load is at the first level, and the output voltage drops below said second threshold by the substantially same certain time duration when the load is at the second level.

4. A control circuit according to claim 1, said detection circuit comprises:
a comparing circuit to compare the output voltage with a reference,
a first circuit to detect the power level of the load, and
a second circuit to set either the first threshold or the second threshold as the reference for the comparing circuit, according to the detected power level of the load.

5. A control circuit according to claim 4, wherein said first circuit comprises:
a current detector to detect a current from the power supply unit to the power-variable load, and
a processing circuit to determine the power level of the load according to the detected current;
or said first circuit comprises an interface to a controller of the appliance to receive the power level of the load.

6. A control circuit according to claim 1, wherein said configuring circuit is adapted to configure the appliance into a setting, among a plurality of settings, according to how many interruptions of the input power are detected.

7. A control circuit according to claim 6, wherein said configuring circuit is adapted to:
start counting the interruption when the interruption is detected for a first time;
time a period and count an interruption if the interruption occurs within the period, and start over the timing and counting;
stop counting if no interruption occurs within a last period; and
configure the appliance in the setting according to a number of the counted interruptions.

8. A control circuit according to claim 1, wherein the configuring circuit is adapted to configure the appliance to a next setting in a sequence of settings each time the interruption of the input power is detected.

9. A LED driving appliance comprising a power supply unit and a control circuit according to claim 1.

10. A LED lighting appliance comprising the LED driving appliance according to claim 9 and a LED lighting arrangement as the variable load.
